(19) United States
(12) Patent Application Publication
(10) Pub. No.: US 2007/0248741 A1
(43) Pub. Date: Oct. 25, 2007

(54) Drinkable oatmeal and method

(76) Inventors: David V. Foster, Mount Prospect, IL (US); Christopher True, Bartlett, IL (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(21) Appl. No.: 11/409,152

(22) Filed: Apr. 21, 2006

(51) Int. Cl. A23L 1/164

(52) U.S. Cl. 426/620

(57) ABSTRACT

A drinkable oatmeal product comprises an oat component and water, both in a retortable container. The product is commercially sterilized or sanitized. The container may be a cup so as to provide one-handed convenience for consumers. The product may include a fruit component, such as a fruit juice, a yogurt containing fruit, a fruit puree, a fresh fruit, and/or a fruit preserve. Methods of preparing the oatmeal product are also provided.

### TECHNICAL FIELD

The invention relates to a drinkable oatmeal and a method of its preparation.

### BACKGROUND OF THE INVENTION

The nutritional value and health benefits of oatmeal are well known and recognized. The consumption of oatmeal has been shown to reduce total cholesterol concentrations in humans, among other benefits. High concentrations of cholesterol are linked to a higher likelihood of heart attacks. Thus, there is a need for increased consumption of oatmeal. Traditionally, a bowl and spoon have been required to eat hot, prepared oatmeal, preventing oatmeal from being conducive to “on-the-go” consumption. Consequently, such consumption of oatmeal can be viewed as being inconvenient. Even with the development of quick oats, oats still require cooking and typically are consumed with a spoon and bowl. Afterwards, the spoon, bowl and any utensils used for cooking the oatmeal need to be cleaned.

A need exists for an oatmeal product that has the same types of health benefits of traditional prepared oatmeal yet is convenient and easy to consume “on-the-go.” A need also exists for such an oatmeal product to be convenient and not messy to consume and which has good texture and flavor characteristics.

### SUMMARY OF THE INVENTION

A drinkable oatmeal product has been invented that provides convenience for consumers and can have traditional and non-traditional flavors that make the product appealing to a much broader audience than traditional quick and instant oatmeals. In one embodiment, the drinkable oatmeal product comprises a ready-to-drink fluid food. The fluid food comprises water and an oat component composed of cooked oats and/or oat flour. Additional components can be included as desired. The fluid food can be packaged in a suitable container, which may be a retortable container. Typically, the drinkable oatmeal product of this embodiment will be sterilized in the retortable container. It is also anticipated that typically the oat component would be cooked before sterilization. Sterilization could occur before or after packaging and sealing in the container.

In another aspect of the invention, a method of making a commercially sterile drinkable fluid oatmeal product is provided. The method includes combining water with an oat component. Sweeteners and flavors and other ingredients may be added as desired. The oat component comprises oats and/or oat flour. The method also includes cooking the oat component and sterilizing the oat component to commercial sterilization standards; and packaging the oat component into a sealed container.

In accordance with another aspect of the invention, the product is contained in a retortable container that can be a sealed microwaveable cup.

In another embodiment, the drinkable oatmeal product comprises a fluid food and a fruit component. The fluid food is composed of water and an oat component composed of cooked oats and/or oat flour. The fruit component may comprise fruit juice, yogurt containing fruit, fruit puree, fresh fruit, and/or a fruit preserve. The drinkable oatmeal product of this embodiment has a pH of about 4.6 or less.

In another aspect of the invention, a method of making a commercially sanitized drinkable oatmeal product is provided. The method includes combining water with an oat component. The oat component comprises oats and/or oat flour.

Sweeteners and flavors and other ingredients may be added to the products of the present invention as desired. The method also includes cooking the oat component and adding to the oat component a fruit component and optionally an acidulent. The fruit component and optional acidulent are added in a quantity sufficient so that the product has a pH of about 4.6 or less. The fruit component is a fruit juice, a yogurt containing fruit, a fruit puree, a fresh fruit, and/or a fruit preserve. The method further includes sanitizing the oat component to commercial sanitization standards and packaging the oat component into a sealed container.

Typically, the drinkable oatmeal product in accordance with the invention will have greater than about 0.8 grams of soluble fiber per 250 grams of the fluid food and may have greater than about 2.5 grams of total fiber per 250 grams of the fluid food.

In accordance with another aspect of the present invention, the drinkable oatmeal product comprises fluid food that comprises from about 5% to about 15% oats and from about 70% to about 85% total water all by weight of the fluid food.

### BRIEF DESCRIPTION OF THE FIGURES

FIG. 1 is a perspective view of a product in accordance with the invention;

FIG. 2 is a perspective view of the product of FIG. 1 being opened; and

FIG. 3 is a sectional elevation view of the product of FIG. 1.

### DETAILED DESCRIPTION OF THE INVENTION

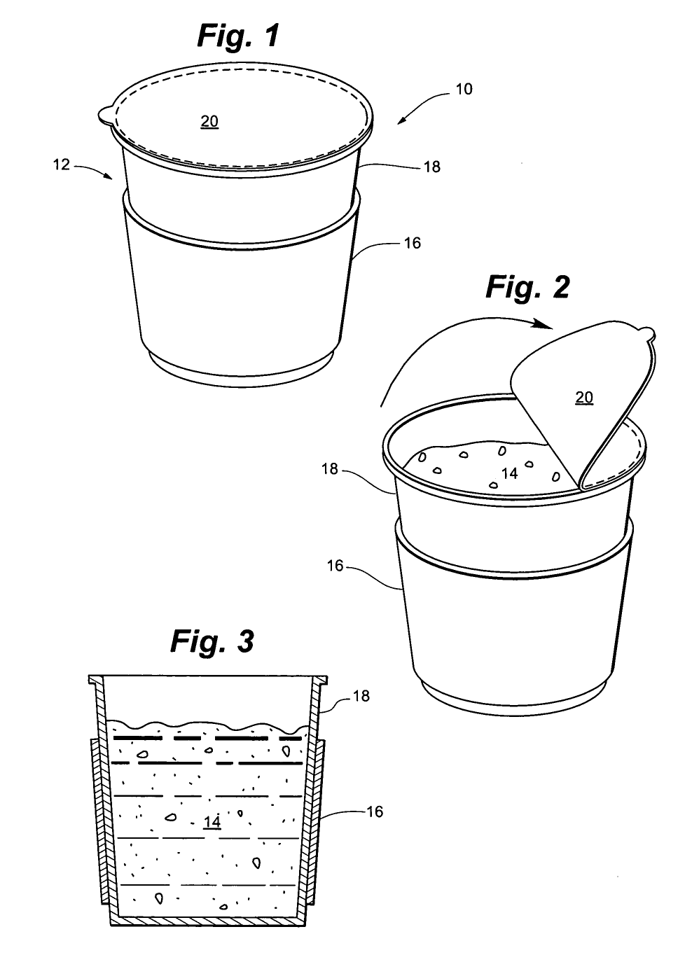

Referring to FIGS. 1-3, there is illustrated a drinkable oatmeal product 10 in accordance with the invention. Drinkable oatmeal product 10 includes a sealed, retortable, microwaveable container 12, a fluid food 14 and a protective sleeve 16.

Container 12 includes a cup portion 18 and a removable cover 20. Removable cover 20 can be peeled off cup portion 18 as illustrated in FIG. 2 to permit a consumer to drink fluid food 14. Alternatively, any suitable container could be used in place of container 12, including a plastic or glass bottle, a metal can or a pouch, for example. Desirably, container 12 is retortable when sealed with fluid food 14 contained therein.

Protective sleeve 16 is provided to insulate the consumer's hand (not shown) that grasps container 12 during handling and consumption, for example, particularly after heating, which may be by microwave heating.

Protective sleeve 16 can be constructed of any suitable material, such as paper, paperboard, cardboard or plastic, for example. Protective sleeve 16 can be provided as a removable sleeve, if desired.

Fluid food 14 contained in container 12 has been retorted after container 12 was sealed with fluid food contained therein.

Fluid food 10 includes oats, oat flour and combinations thereof. The oats can include whole oats, whole groats, or broken groats. Whole groats and broken groats can include rolled oats (old-fashioned and instant types), cut oats and crushed oats. Instant oats is a preferred form of oats.

Another important aspect of fluid food 10 is water. There should be enough water in fluid food 10 to make the oatmeal drinkable. Preferably, there is sufficient water to give fluid food 10 a readily flowable rheology and a texture. Preferably, fluid food 10 contains from about 5% to about 15% oats and from about 70% to about 85% or 90% total water, all by weight of the total fluid food. The balance can contain sweeteners, flavors, fruits and other materials as desired.

The water should be suitable for use in food. The total water may come in part or in whole from other parts of the fluid food, especially if juices or other water containing components are used.

In another embodiment, the fluid food may also include a fruit component. The fruit component can include fruit juice, yogurt containing fruit, fruit puree, fresh fruit, fruit preserves, fruit sorbet, fruit sherbet and combinations thereof. Typically, the fruit component has particles sufficiently small that the drinkable food component may be safely swallowed without chewing. In this embodiment, preferably, there is either a sufficient fruit component, or an acidulant present, so that the fluid food has a pH of less than about 4.6. Even with fruit, optionally an acidulent, especially a fruit acid, may be used to lower the pH below about 4.6. Generally, retorting is not required for products having a pH of below about 4.6.

Suitable sweeteners and flavors can be included in the products of the present invention to provide a desired sweetness and flavor. For example, brown sugar and maple flavor sugar can be used. Spices, in particular, cinnamon, can be used. In addition, any desired flavor or flavors can be used.

The product of the invention may contain many other ingredients, as desired. Examples of optional additional ingredients include, but are not limited to, salt, hydrocolloids, polysaccharides, thickeners, sweeteners—artificial or natural, caffeine, dairy, coffee solids, tea solids, herbs, nutraceutical compounds, electrolytes, vitamins, minerals, amino acids, preservatives, alcohol, colorants, emulsifiers, and oils as known in the art.

Preferably, the fluid food provides at least 0.8 grams of soluble fiber per serving and at least 2.5 grams of total fiber content per serving. It is well known in the art how to vary the amounts and types of different parts of the fluid food to achieve a desired fiber content.

Generally, the fluid food is packaged inside a sealed container. Preferably, the container is a cup. The cup may be made of plastic and sealed with a closure incorporating an easy open, spill resistant drinking spout. The cup may be contoured for easy gripping and wrapped in an insulated sleeve to keep the product warm and then make the container comfortable to handle when hot. On the other hand, the entire body of the container may be insulated. Preferably, the container is microwavable so that the oatmeal can be conveniently heated especially during the winter. The cup provides one-handed convenience to consumers, thereby allowing consumers to eat the drinkable oatmeal without a spoon and while the consumer is on the go.

The container should be retortable, sterilizable or sanitizable if the container is to be retorted, sterilized or sanitized. Preferably, the seal of the container should allow the product to be maintained in a commercially sterilized or sanitized state during normal distribution of the product.

Generally, the product is commercially sterilized or sanitized so that the product is shelf-stable. A shelf-stable product reduces distribution costs versus a refrigerated item. It also allows consumers to not cook the oatmeal before drinking the oatmeal, which is a plus during the summer.

Commercial sterilization of low acid food is generally accomplished by retorting the food under sufficient pressure and temperature for a time sufficient to kill the microbe that causes botulism. Commercial sanitization of high acid foods occurs under gentler pressure and temperature conditions than commercial sterilization. Both processes render food shelf-stable. High acid foods have a pH lower than about 4.6 and low acid foods have a pH higher than about 4.6. The container can be commercially sterilized or sanitized by other methods including the application of hydrogen peroxide. Commercial sterilization can be determined as is known in the art by inoculating food with spores of the bacteria Bacillus subtillis var. globigii and subjecting the inoculated sample to the sterilization process and checking to determine if at least a 6 log reduction of viable spores after sterilization has occurred. Commercial sanitization can be determined as is known in the art by inoculating food with spoilage organisms, such as ascospores of the yeast Saccharomyces cerevisiae, and subjecting the inoculated sample to the sanitization process and checking to determine if at least a 5 log reduction of viable acrospores after sanitization has occurred.

The drinkable oatmeal product may be made by combining water with an oat component selected from the group consisting of oats, oat flour and combinations thereof. The oat component is cooked in the water. Preferably, the oat component is fully gelatinized after cooking. The cooking can occur in a batch fashion or a continuous fashion. Additional ingredients, as discussed earlier, including but not limited to sweeteners and flavors, may be added to the oat component before, during or after cooking of the oat component.

The oat component is sterilized or sanitized and the oat component is packaged in a container. The order of processing can be varied. Thus, the oat component can be sterilized or sanitized and then aseptically packaged into a container, or the oat component can be packaged first and the packaged oatmeal component can be retorted to commercial sterilization or sanitization standards. Furthermore, the oat component can be packaged prior to cooking and cooked during the retorting. The cooked oat component may be commercially sanitized if the fluid food has a pH of about 4.6 or less.

The package is sealed so that the drinkable oatmeal product remains commercially sterile or sanitized during normal distribution of the product. Preferably, the container is not insulated if the oatmeal component is retorted after packaging as this would increase the processing time. In this case, an insulating sleeve could be affixed to or otherwise packaged with the container after retorting.

For each of the examples, the oats were cooked before the addition of any additional ingredients.

### EXAMPLE 1

The composition of the fluid food of this example is shown in the table below.

| Ingredients | % by Total Weight |
|---|---|
| Cooked oats | 10.00% |
| Yogurt, vanilla | 20.00% |
| Mango | 20.00% |
| Peaches | 20.00% |
| Mango sorbet | 30.00% |

The ingredients were mixed together thoroughly, water was added as necessary, the mixture was packaged into a container, and finally retorted to commercial sanitization standards.

The resulting product had the consistency of a fruit smoothie but with a noticeable particulate mouthfeel from the oats.

### EXAMPLE 2

The composition of the fluid food of this example is shown in the table below.

| Ingredients | % by Total Weight |
|---|---|
| Cooked oats | 12.50% |
| Pineapple | 12.50% |
| Orange juice | 12.50% |
| Orange sherbet | 25.00% |
| Strawberries | 18.75% |
| Peaches | 18.75% |

The drinkable oatmeal product was prepared the same way as Example 1. The resulting product had the consistency of a fruit smoothie but with a noticeable particulate mouthfeel from the oats.

### EXAMPLE 3

The composition of the fluid food of this example is shown in the table below.

| Ingredients | % by Total Weight |
|---|---|
| Orange juice | 25.00% |
| Non-fat yogurt | 16.67% |
| Frozen strawberries | 16.67% |
| Bananas | 16.67% |
| Orange sherbet | 16.67% |
| Cooked oats | 8.33% |

The drinkable oatmeal product was prepared the same way as Example 1. The resulting product had the consistency of a fruit smoothie but with a noticeable particulate mouthfeel from the oats.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims.

1. A drinkable oatmeal product comprising:
a fluid food composed of an oat component selected from the group consisting of cooked oats, oat flour and combinations thereof; and water; and is contained in a retortable container that contains the fluid food.

2. The drinkable oatmeal product of claim 1 wherein the fluid food in the container is sterilized.

3. The drinkable oatmeal product of claim 2 wherein the retortable container is a sealed microwavable cup.

4. The drinkable oatmeal product of claim 2 wherein the oat component is cooked before sterilization.

5. The drinkable oatmeal product of claim 1 further comprising a fruit component selected from the group consisting of fruit juice, yogurt containing fruit, fruit puree, fresh fruit, fruit preserves and combinations thereof.

6. The drinkable oatmeal product of claim 1 wherein the product provides greater than about 0.8 grams of soluble fiber per 250 grams of fluid food.

7. The drinkable oatmeal product of claim 1 wherein the product provides greater than about 2.5 grams of total fiber per 250 grams of fluid food.

8. The drinkable oatmeal product of claim 1 further comprising a flavor.

9. The drinkable oatmeal product of claim 1 wherein the fluid food comprises from about 5% to about 15% oats and from about 70% to about 90% total water, all by weight of the total fluid food.

10. A drinkable oatmeal product comprising:
a fluid food composed of an oat component selected from the group consisting of cooked oats, oat flour and combinations thereof; water; and a fruit component selected from the group consisting of fruit juice, yogurt containing fruit, fruit puree, fresh fruit, fruit preserves and combinations thereof, wherein the fluid food has a pH of about 4.6 or less.

11. The drinkable oatmeal product of claim 10 further comprising a sealed microwavable cup containing the fluid food.

12. The drinkable oatmeal product of claim 10 wherein the product provides greater than 0.8 grams of soluble fiber per 250 grams of fluid food.

13. The drinkable oatmeal product of claim 10 wherein the product provides greater than 2.5 grams of total fiber per 250 grams of fluid food.

14. The drinkable oatmeal product of claim 10 further comprising a flavor.

15. A method of making a commercially sterile drinkable fluid oatmeal product comprising:
(a) combining water with an oat component selected from the group consisting of oats, oat flour and combinations thereof;
(b) cooking the oat component;
(c) sterilizing the oat component to commercial sterilization standards; and
(d) packaging the oat component into a sealed container.

16. The method of claim 15 wherein the fluid oatmeal product is sterilized by retorting after said packaging.

17. The method of claim 15 further comprising sealing the container so that the drinkable oatmeal product remains commercially sterile during normal distribution of the product.

18. The method of claim 15 further comprising adding a fruit component to the oat component, the fruit component selected from the group consisting of fruit juice, yogurt containing fruit, fruit puree, fresh fruit, fruit preserves and combinations thereof.

19. The method of claim 15 further comprising adding a flavor to the oat component.

20. The method of claim 15 wherein the product comprises the oat component in an amount of from about 5% to about 15% and the water in an amount of from about 70% to about 90% total water, all by weight of the fluid oatmeal product.

21. A method of making a commercially sanitized drinkable oatmeal product comprising:
(a) combining water with an oat component selected from the group consisting of oats, oat flour and combinations thereof;
(b) cooking the oat component;
(c) adding to the oat component a fruit component selected from the group consisting of fruit juice, yogurt containing fruit, fruit puree, fresh fruit, fruit preserves, and optionally an acidulent, so that the product has a pH of about 4.6 or less;
(d) sanitizing the oat component to commercial sanitization standards; and
(e) packaging the oat component into a sealed container.

22. The method of claim 21 further comprising sealing the container so that the drinkable oatmeal product remains commercially sanitized during commercial distribution of the product.

23. The method of claim 17 further comprising adding a flavor to the oat component.
